(19) United States
(12) Patent Application Publication
(10) Pub. No.: US 2026/0077662 A1
(43) Pub. Date: Mar. 19, 2026

(54) VEHICLE NON-CONTACT CHARGING SYSTEM

(71) Applicant: TOYOTA JIDOSHA KABUSHIKI KAISHA, Toyota-shi (JP)

(72) Inventor: Kotaro WADA, Nagakute-shi (JP)

(73) Assignee: TOYOTA JIDOSHA KABUSHIKI KAISHA, Toyota-shi (JP)

(21) Appl. No.: 19/199,620

(22) Filed: May 6, 2025

(30) Foreign Application Priority Data
Sep. 19, 2024 (JP) 2024-162275

(51) Int. Cl. B60L 53/12; B62D 21/15

(52) U.S. Cl. CPC B60L 53/12; B62D 21/155

(57) ABSTRACT

A vehicle non-contact charging system includes a road surface interference guard member provided in front of a vehicle on a bottom surface of the vehicle, a non-contact charging unit that is separated from the road surface interference guard member and is fastened to a bottom surface of the vehicle behind the road surface interference guard member, and is movable relative to the road surface interference guard member in a vertical direction of the vehicle, wherein the non-contact charging unit has an inclined portion that is formed to be inclined rearward with respect to a longitudinal direction of the vehicle, and the inclined portion is configured such that a lower end portion is lower than a lower end portion of the road surface interference guard member.

### CROSS-REFERENCE TO RELATED APPLICATION

This application claims priority to Japanese Patent Application No. 2024-162275 filed on Sep. 19, 2024. The disclosure of the above-identified application, including the specification, drawings, and claims, is incorporated by reference herein in its entirety.

### BACKGROUND

### 1. Technical Field

The present disclosure relates to a vehicle non-contact charging system.

### 2. Description of Related Art

Japanese Unexamined Patent Application Publication No. 2014-128124 (JP 2014-128124 A) discloses a technology of a structure in which an inclined portion is provided at the front of a non-contact charging unit to avoid road surface interference without affecting power supply efficiency.

### SUMMARY

In plug-in hybrid electric vehicles (PHEVs) and battery electric vehicles (BEVs), a road surface interference guard for protecting a non-contact charging unit mounted under the floor of the vehicle from a road surface is provided at the front of the vehicle. The road surface interference guard is often formed to be long in a vehicle front-rear direction, and cannot be mounted on the vehicle unless it is separated from the non-contact charging unit and is provided at a portion of the vehicle that is movable relative to the non-contact charging unit. In this case, the road surface interference guard exhibits a guard function including variations due to fastening to the vehicle. Therefore, the lower end needs to be always lower than the lower surface of the non-contact charging unit, including a case where the relative movement to the non-contact charging unit is maximum, and there is a problem that the ground clearance of the vehicle decreases.

In JP 2014-128124 A, however, no consideration is given to the case where the road surface interference guard is provided, and there is room for improvement.

The present disclosure has been made in view of the above, and an object thereof is to provide a vehicle non-contact charging system that can exhibit a road surface interference guard function without a decrease in a vehicle ground clearance.

To solve the above problem and achieve the above object, a vehicle non-contact charging system according to the present disclosure includes:
a road surface interference guard member provided on a vehicle front side of a bottom surface of a vehicle; and
a non-contact charging unit that is separated from the road surface interference guard member, fastened to the bottom surface of the vehicle behind the road surface interference guard member, and movable relative to the road surface interference guard member up and down in a vertical direction of the vehicle.

The non-contact charging unit includes an inclined portion that is inclined rearward with respect to a longitudinal direction of the vehicle.

A lower end of the inclined portion is lower than a lower end of the road surface interference guard member.

The present disclosure attains an effect that the road surface interference guard function can be exhibited without a decrease in the vehicle ground clearance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a partial cross-section of a vehicle according to one embodiment; and

FIG. 2 is a schematic view of another partial cross-section of a vehicle according to an embodiment.

### DETAILED DESCRIPTION OF EMBODIMENTS

Hereinafter, a vehicle including a vehicle non-contact charging system according to an embodiment of the present disclosure will be described with reference to the drawings. The constituent elements in the following embodiments include those that can be easily replaced by a person skilled in the art or those that are substantially the same. In addition, the drawings referred to in the following description only schematically show shapes, sizes, and positional relationships to the extent that the contents of the present disclosure can be understood. That is, the present disclosure is not limited to only the shapes, sizes, and positional relationships illustrated in the drawings.

### Configuration of the Vehicle

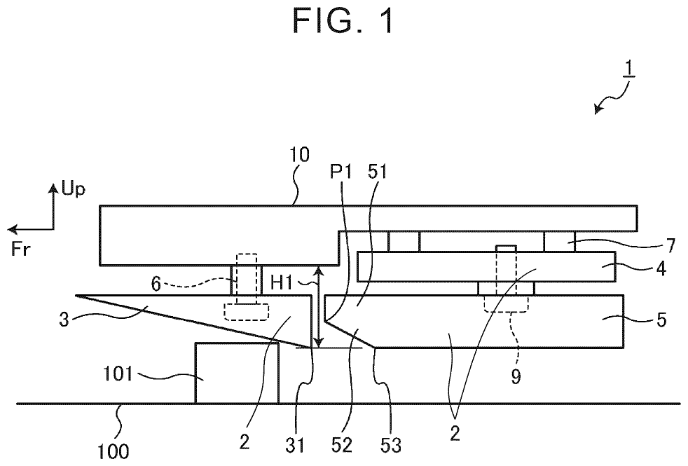

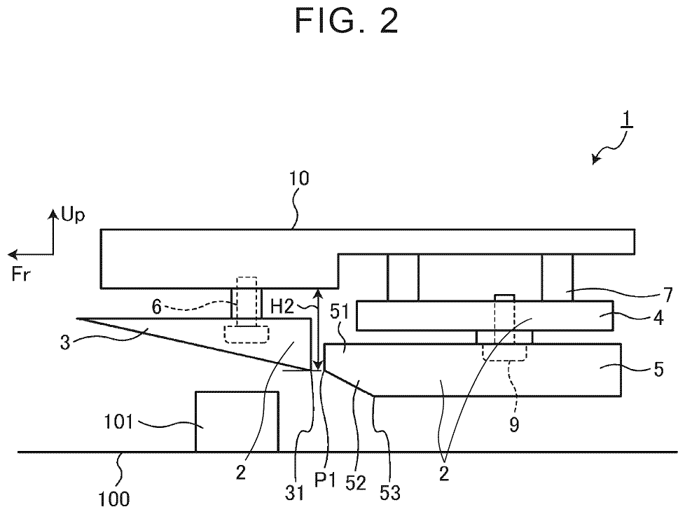

FIG. 1 is a schematic diagram of a partial cross-section of a vehicle according to an embodiment. FIG. 2 is a schematic view of another partial cross-section of a vehicle according to an embodiment. In FIG. 1 and FIG. 2, the right side indicates the front side (Fr) of the vehicle 1, and the up-down direction indicates the vertical direction of the vehicle 1. The vehicle 1 shown in FIG. 1 includes a vehicle non-contact charging system 2 on a bottom surface of a body 10.

The vehicle non-contact charging system 2 includes a road surface interference guard member 3 provided in front of the vehicle on the bottom surface of the body 10 of the vehicle 1. Further, the vehicle non-contact charging system 2 includes a suspension member 4 fastened to the rear of the road surface interference guard member 3 and a non-contact charging unit 5 fastened to the suspension member 4, which are the bottom surfaces of the body 10 of the vehicle 1.

The road surface interference guard member 3 is fastened to the body 10 via a screw 6 so as to be able to expand and contract in the vertical direction of the vehicle 1. The road surface interference guard member 3 is formed so as to be inclined from the front toward the rear with respect to the longitudinal direction (front-rear direction) of the vehicle 1. Specifically, the road surface interference guard member 3 is formed so as to be inclined from the front toward the direction such that an angle formed between the upper surface on the body 10 side and the inclined surface is an acute angle. The road surface interference guard member 3 suppresses interference of the non-contact charging unit 5 with the curbstone 101 or the like on the road surface 100 when the vehicle 1 travels.

The suspension member 4 is extensibly fastened in the vertical direction of the vehicle 1 via an extendable bush 7. The suspension member 4 may be fastened to the vehicle 1 via a mount such as rubber instead of the bush 7.

Non-contact charging unit 5 has an inclined portion 52 formed by forming toward the rear with respect to the longitudinal direction of the base portion 51 and the vehicle 1 which incorporates a power receiving unit configured by using a coil or the like for receiving power from the outside (not shown). The inclined portion 52 is formed at the same inclination angle as the road surface interference guard member 3. The non-contact charging unit 5 is separated from the road surface interference guard member 3 and is fastened to the bottom surface of the vehicle 1 behind the road surface interference guard member 3 via a screw 9, a suspension member 4, and a bush 7. Thus, the non-contact charging unit 5 is separated from the road surface interference guard member 3 and is fastened to the vehicle 1 so as to be movable relative to the road surface interference guard member 3.

As illustrated in FIG. 1, the non-contact charging unit 5 configured as described above is configured such that the lower end portion 53 is lower than the lower end portion 31 when the road surface interference guard member 3 moves most downward in the vertical direction of the vehicle 1. The lower end portion 53 is a lower end portion of the inclined portion 52 in the non-contact charging unit 5, and the lower end portion 31 is a lower end portion of the road surface interference guard member 3. That is, the non-contact charging unit 5 is configured such that the height from the bottom surface of the body 10 to the lower end portion 53 is longer than the height H1 from the bottom surface of the body 10 to the lower end portion 31 of the road surface interference guard member 3 with the road surface interference guard member 3 extending most. The body 10 is a body of the vehicle 1 including the suspension member 4 and the bush 7.

Further, as shown in FIG. 2, the non-contact charging unit 5 is configured such that the inclination start point P1 is positioned lower than the lower end portion 31 when the road surface interference guard member 3 moves uppermost in the vertical direction of the vehicle 1. The inclination start point P1 is an inclination start point of the inclined portion 52 in the non-contact charging unit 5, and the lower end portion 31 is a lower end portion of the road surface interference guard member 3. That is, the non-contact charging unit 5 is configured such that the height from the bottom surface of the body 10 to the inclination start point P1 of the inclined portion 52 is longer than the height H2 from the bottom surface of the body 10 to the lower end portion 31 of the road surface interference guard member 3 in which the road surface interference guard member 3 is most contracted. The body 10 is a body of the vehicle 1 including the suspension member 4 and the bush 7. Thus, the non-contact charging unit 5 can exert the road surface interference guard function of the road surface interference guard member 3 without lowering the ground height of the vehicle 1.

According to the embodiment described above, when the road surface interference guard member 3 moves most downward in the vertical direction of the vehicle 1, the lower end portion 53 of the inclined portion 52 of the non-contact charging unit 5 is configured to be lower than the lower end portion 31 of the road surface interference guard member 3. Therefore, the road surface interference guard function of the road surface interference guard member 3 is exhibited without lowering the vehicle ground height of the vehicle 1.

Further, according to the embodiment, when the road surface interference guard member 3 moves most upward in the vertical direction of the vehicle 1, the non-contact charging unit 5 is configured such that the inclination start point of the inclined portion 52 in the non-contact charging unit 5 is located lower than the lower end portion 31 of the road surface interference guard member 3. Therefore, the road surface interference guard function of the road surface interference guard member 3 is exhibited without lowering the vehicle ground height of the vehicle 1.

Additional benefits and variations can be readily derived by one of ordinary skill in the art. The broader aspects of the disclosure are not limited to the specific details and representative embodiments presented and described above. Accordingly, various modifications may be made without departing from the spirit or scope of the general inventive concept as defined by the appended claims and their equivalents.

While some of the embodiments of the present application have been described in detail with reference to the drawings, these are merely examples, and the present disclosure can be implemented in other forms in which various modifications and improvements are made based on the knowledge of a person skilled in the art, including the aspects described in the section of the disclosure of the present disclosure.

What is claimed is:

1. A vehicle non-contact charging system comprising:
a road surface interference guard member provided on a vehicle front side of a bottom surface of a vehicle; and
a non-contact charging unit that is separated from the road surface interference guard member, fastened to the bottom surface of the vehicle behind the road surface interference guard member, and movable relative to the road surface interference guard member up and down in a vertical direction of the vehicle, wherein
the non-contact charging unit includes an inclined portion that is inclined rearward with respect to a longitudinal direction of the vehicle, and
a lower end of the inclined portion is lower than a lower end of the road surface interference guard member.

2. The vehicle non-contact charging system according to claim 1, further comprising a suspension member that is provided on the bottom surface of the vehicle and is extensible and contractible up and down in the vertical direction of the vehicle, wherein
the non-contact charging unit is fastened to the vehicle via the suspension member, and
the inclined portion is provided on a front side of the non-contact charging unit.

3. The vehicle non-contact charging system according to claim 2, wherein, when the road surface interference guard member moves uppermost in the vertical direction of the vehicle, an inclination start point at which the inclined portion is inclined is positioned lower than the lower end of the road surface interference guard member.
